(19) United States
(12) Patent Application Publication
(10) Pub. No.: US 2003/0117251 A1
(43) Pub. Date: Jun. 26, 2003

(54) Controllable transformer

(75) Inventors: Espen Haugs, Sperrebotn (NO); Frank Strand, Moss (NO)

Correspondence Address: Finnegan, Henderson, Farabow,, Garrett & Dunner, L.L.P., 1300 I Street, N.W., Washington, DC, 20005-3315, US

(73) Assignee: MAGTECH AS.

(21) Appl. No.: 10/300,752

(22) Filed: Nov. 21, 2002

Related U.S. Application Data
(63) Continuation of application No. 60/333,136, filed on Nov. 27, 2001.

(30) Foreign Application Priority Data
Nov. 21, 2001 (NO) 20015689

(51) Int. Cl. H01F 27/28

(52) U.S. Cl. 336/182

(57) ABSTRACT

A controllable transformer device comprising a body (1) of a magnetic material, a primary winding (4) wound round the body (1) about a first axis, a secondary winding (2) wound round the body (1) about a second axis at right angles to the first axis, and a control winding (3) wound round the body (1) about a third axis, coincident with the first axis.

The present invention relates to a variable transformer/frequency converter device according to patent claim 1.

The transformer device is preferably designed as a hollow magnetisable core with an internal winding compartment for internal windings and an external winding compartment for external windings. In a preferred embodiment it comprises 3 windings, a primary winding in the external winding compartment with associated control winding in the internal winding compartment, and a secondary winding in the internal winding compartment. The windings in the external winding compartment and the windings in the internal winding compartment are aligned at right angles (perpendicular) to each other in the compartment, thereby creating magnetic fields that are orthogonal. The internal winding compartment may of course house the primary winding and the external winding compartment may house the secondary winding and the control winding. The frequency converter is specially, but not in a limiting manner, intended for use in the MVA range.

The invention is a further development of the device set forth in PCT/NO01/00217, which is hereby included in the present invention in its entirety.

A transformer of this kind is previously known per se from U.S. Pat. No. 4,210,859 of Apr. 18, 1978. However, the known solution manifests the following disadvantages.

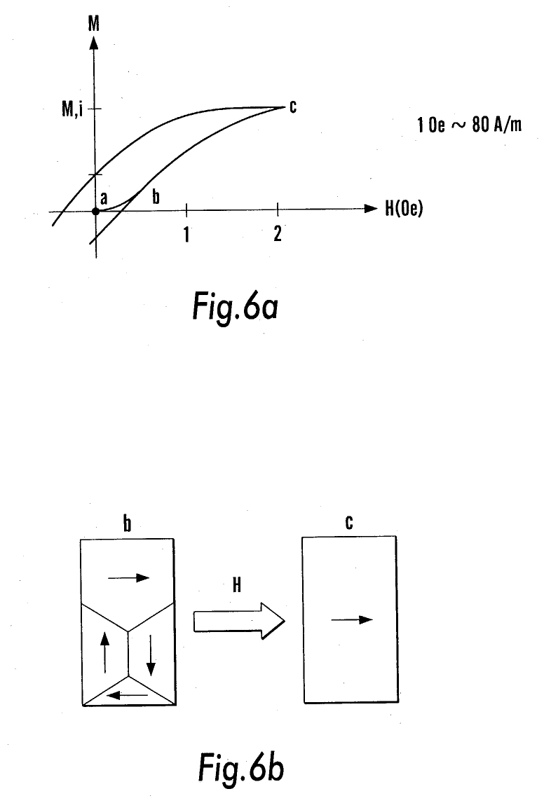

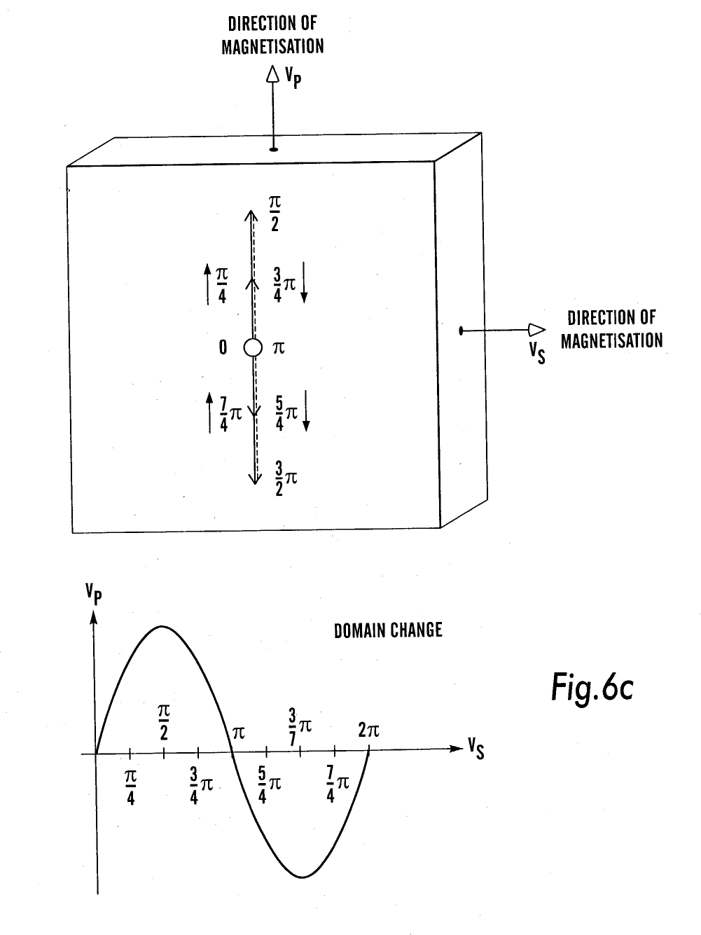

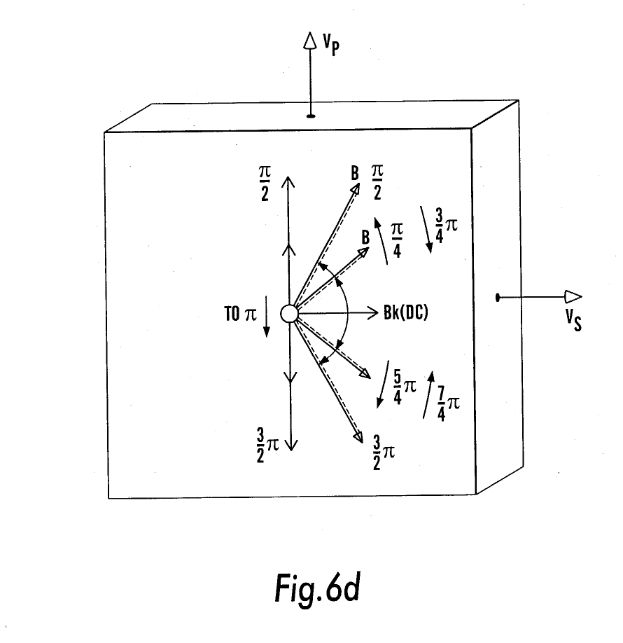

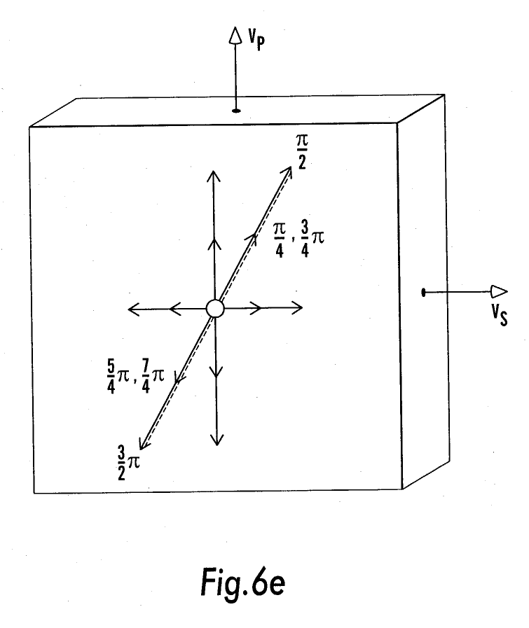

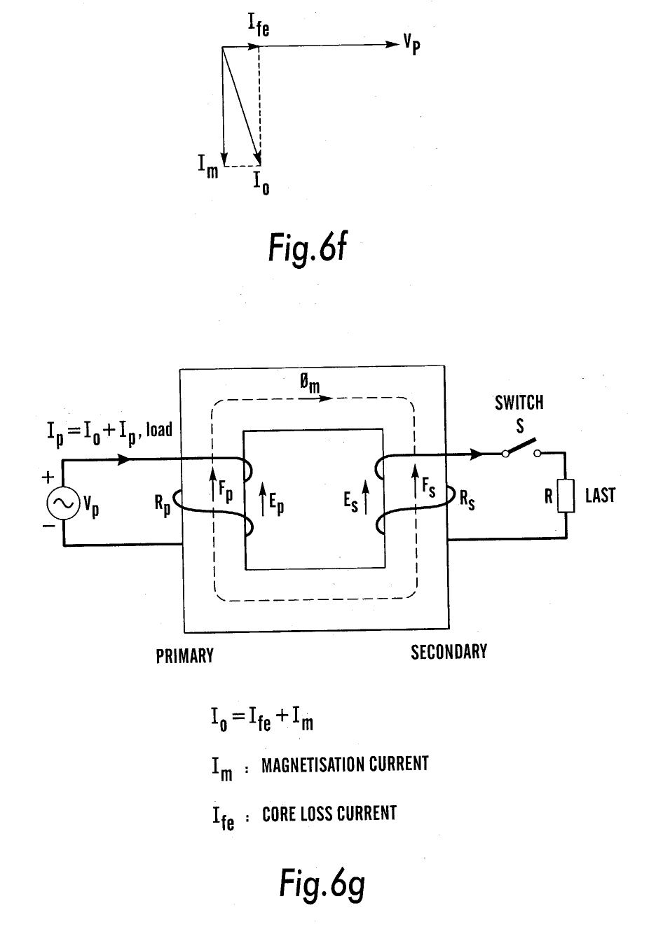

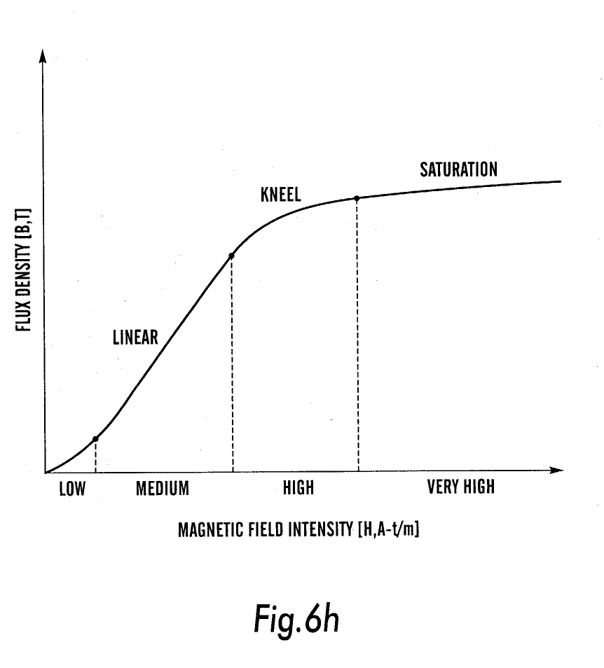

I. In the publication a device is described which is developed on the basis of a test conducted on a ferrite pot core with dimensions 18×11 mm, and with current levels in the mA range. Ferrite, however, is not suitable for use at high power levels, due amongst other things to the substantial costs involved. This is on account of the fact that the size of a ferrite core is limited purely from the production engineering point of view and because higher power levels can be transferred by increasing the frequency of the voltage that has to be converted, but this in turn leads to complicated and expensive power electronics. The invention is therefore aimed at the use of core plate, which has special properties with regard to permeability, these properties being employed in the invention. FIG. 6f illustrates the linear part of the magnetisation curve for a standard commercial core plate. It will be an advantage that the magnetisation curve is the same for all directions in the plate. It involves the use of non-directional plate without this being considered as limiting for the application, since for some applications it may be advantageous to have a directionally oriented plate.

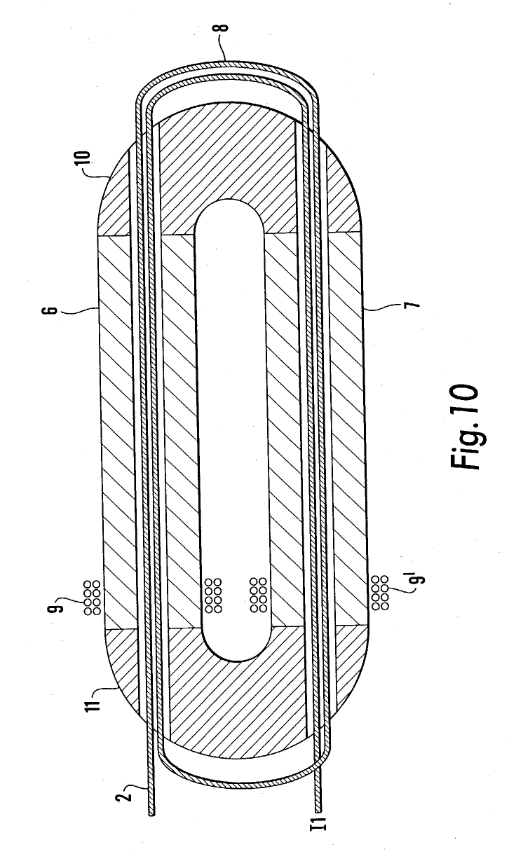

II. FIG. 10 in the American patent illustrates a connection diagram for a variable transformer solution with 4 windings: a primary main winding, a secondary main winding and two control windings, one for each main winding. The mode of operation is such that a variable DC current in both control windings will result in a transfer of AC voltage from the primary to the secondary winding, which is arranged at right angles to the primary winding. In practice it will not be realistic to construct a transformer of this kind, particularly if the area of application is outside the mA range. A DC current in the control windings will rotate the domains in an unfavourable direction for connection in one half cycle of the primary voltage, causing harmonics in the secondary voltage.

FIGS. 6c to 6d illustrate this. In FIG. 6c the domains are aligned according to the primary voltage and will vary roughly as shown in the figure. The phase shift of the magnetisation in relation to the primary voltage is not included here in order to simplify the illustration, (the magnetisation current lags 90 degrees behind the voltage). The magnetisation from the primary winding becomes a sinusoidal domain change in a fixed direction in the material given by the primary winding's direction in the compartment.

Mkvp=Kvp·sin(ω·t) 1)

It is now not possible to activate the secondary winding without a control current being impressed from outside in the control winding or the secondary winding, rotating the magnetisation from the primary winding so that the field also passes through the secondary winding. The length of the arrow illustrates the magnetisation level or the field strength and the direction of the arrow the direction of the domains.

In FIG. 6d a control field Mkdc is introduced that is added to the primary field, establishing a magnetisation as illustrated. Since a sinusoidal field is added to a constant field, the sum will change sinusoidally in direction and sinusoidally in field strength. The simplified diagram 9d illustrates that we obtain a domain change that becomes a product of two sinus functions. Both direction and field strength are changed sinusoidally.

The induced voltage in the secondary winding will be given by two functions. The fact that the domains change direction will give an induction and the fact that the domains change in size will give an additional induction.

The directional dependence is given by

Mkr−Mkvp+Mkdc 2)

The field strength is given by 1), and the product of these two domain changes gives

Mkp=Mkr·Mkvp 3)

Simplified to

Mkp=Kvp2·sin²(w·t) 4)

Disregarding constant term

Vs=K₂·cos(2·ψ·t) 5)

This demonstrates a frequency doubling, and shows that a DC magnetisation will not give the intended result. A load change will also cause a phase angle rotation of the secondary voltage relative to the secondary voltage, with the result that in a transformer of this type we obtain both a phase shift and a frequency change.

III. In order to be able to implement a realistic solution for a variable power transformer, the problem arises that the control winding on the primary side is transformatively connected to the primary winding and will be under voltage from the primary side, thereby making it very difficult to regulate without extensive filtering.

IV. The American patent also discloses a transformer connection (FIG. 18) where windings with right-angled axes are interconnected in series two by two. The publication states that the core's utilisation can be increased by using such a connection. This is not correct, however, since the magnetic fields for the windings are summed vectorially and the described effect will not be achieved.

V. The American patent also describes (FIG. 20) a variable delay between the input and output voltage in a case where both the control windings carry current and are interconnected in series. Phase distortion is involved here since the fields through the primary and the secondary winding are shifted via the domain directions. With the control windings connected in this manner, it will not work for a power transformer used as a phase inverter, since the connection from the primary winding will influence the control current to such an extent that in principle the same connection as mentioned earlier (FIG. 18) will be obtained.

VI. In general, the problem with the American patent is that it does not present a complete picture of how the manipulation of the domains with a DC control current affect the magnetisation in relation to the connection between two orthogonal windings.

In order to overcome these drawbacks the invention has the following features.

A. According to the invention the magnetisation is controlled as a pulsed DC or pulsed AC control current in a secondary control winding. By controlling the magnetisation in step with increased voltage from the primary winding with an AC control current in the control winding as illustrated in FIG. 6e, the direction of the domains will be kept constant at, e.g., 30 degrees and only the field strength of the magnetisation will be changed in order to avoid a change in both strength and direction simultaneously.

B. For the magnetic circuit, according to the invention this will be achieved by means of an accurate dosing of the control current in relation to the primary winding's magnetisation current and ampere-turn balance with the secondary winding. In an ordinary transformer as illustrated in FIG. 6g, the magnetisation current established by the primary winding will be given by the flux required to generate a counterinduced voltage Ep according to Faraday's law.

$$\vec{I} p = \frac{\vec{V} p - \vec{E} p}{Rp} \qquad 6 )$$

Ep: Voltage induced in the primary winding

Vp: Forced voltage

Rp; Primary winding's resistance

Ip: Primary current

\vec{I}p=\vec{I}fe+\vec{I}m 7)

Disregarding leakage fields, the common flux for primary and secondary winding is given by

$$Φ m = \frac{Np \cdot Im}{Rcore} \qquad 7 )$$

Np: Primary winding's number of turns

Im: The magnetisation current

Rcore: The reluctance in the core

With an open secondary circuit there is only magnetisation current in the primary winding. According to Lenz's law emf=electromotive voltage induced in the secondary winding will be in such a direction that it will counteract the flux change that created it. When the secondary winding is connected to a load (the switch in FIG. 6g is closed), its own magnetomotive force=mmf or flux will immediately (in the transient sequence) be established, which will be in the opposite direction to mmf from the primary winding. This is illustrated in FIG. 6g. In a moment the flux in the core will decrease to

$$Φ m = \frac{Np \cdot im - Ns \cdot is}{Rcore} \qquad 8 )$$

where is is the secondary current and Ns the number of turns in the secondary winding. The flux reduction will lead to a reduction in the induced voltage in the primary winding and thereby according to equation 6) an increase in the primary current. This increased primary current, which is the load current component in the primary current, adds its mmf vectorially to the magnetisation component Np*im, causing an increase in the primary flux

$$Φ m = \frac{Np \cdot im + Np \cdot ip , load - Ns \cdot is}{Rcore} \qquad 9 )$$

The primary current increases until Np·Ip, load=Ns·Is and then Φm and Ep are on the same level as they were before the switch was closed. In stationary operation we will have a current in the primary winding

\vec{I}p=\vec{I}fe+\vec{I}m+Ip,load 10)

When the switch opens the same sequence will be repeated in the opposite direction. It is interesting to note that at the moment when the switch is closed we actually have a secondary mmf, which establishes a magnetisation that is orthogonal to the original magnetisation from the primary winding. The primary winding replies with a corresponding magnetisation mmf oppositely directed to the secondary winding's mmf and orthogonal to the original magnetisation. Thus we see that Lenz's law maintains a balance in the flux, with every load change on the secondary side being met by a corresponding change on the primary side, thus achieving a balance, with the result that in a stationary state we will only have the magnetisation flux flowing in the core that is the cause of the transformer effect. This description applies for an ordinary transformer with primary and secondary winding in the same winding compartment.

According to the invention we shall establish a magnetisation current in the control winding that conforms to the magnetisation current from the primary winding in amplitude in order to enable a transformative connection to be established between the primary and secondary winding that does not produce undesirable frequencies in the secondary voltage. Without this magnetisation we shall not be able to activate transformative connection to the secondary winding. There will be some degree of connection on account of the winding's extension in the compartment, which will provide an induced component and also a second induced component due to nonlinearities in the material, but this connection will not be capable of providing the desired transformative effect.

We have now established a magnetisation in the core that provides connection to the secondary side. We shall therefore have two magnetisation currents, which are orthogonal and are summed in such a manner that the domain direction is changed linearly in a direction that is at an angle to the secondary winding and where induced voltage in the secondary winding will be dependent on the size of this angle.

Since the sum of the magnetisation currents is the cause of the transformer effect, we want to keep the controlled part of the magnetisation current in the secondary circuit unaffected by load changes in the secondary circuit, i.e. the current in the control winding is kept constant during a load change. By introducing a suitable inductance in the control winding, e.g. by means of the prior art from PCT/NO01/00217, the current in the control winding will be perceived as constant during domain changes caused by load changes in the secondary circuit. We should be aware that now that the transformer effect is present, the control winding will also be under induction from the primary voltage. The control winding is also directly transformatively connected to the secondary winding and a control voltage in the control winding will be transformed to the secondary winding. At the same time current in the secondary winding will now influence the domain distortion and the phase ratio between primary and secondary winding. In order to remedy this situation, all currents in the system must be monitored and the control winding must compensate for domain changes established by the secondary winding. In order to prevent power passing from the control circuit to the secondary circuit and these influencing each other, as mentioned earlier we shall introduce an inductance in the control circuit that causes an approximately constant current in the control winding and gives a sufficient drop in voltage between the control winding and the secondary winding. The transformed voltage in the secondary winding from the primary side and the transformed voltage in the secondary winding from the control winding will be in phase or in antiphase, since we have basically used a control voltage that should be in phase with the primary voltage in order to obtain a directionally constant domain change. It is also important to be aware that the core is reset at every zero passage in the voltages. Thus by removing the control current the magnetisation angle between the windings will decrease due to the fact that the secondary current decreases and after a few periods we are back to minimal connection.

We can conclude with the following:

1) The control voltage is in phase or antiphase with the primary voltage in order to achieve distortion-free transformative connection.

2) Through a slow change in the amplitude of the control voltage, the direction of the domain change or the magnetisation angle between primary and secondary winding can be changed and thereby the voltage transfer.

3) Through introduction of an inductance in the control circuit it will be possible to suppress the effect of the direct transformative connection between secondary and control winding.

4) The secondary winding will act as a control winding by mmf therefrom being added to mmf from the control winding and influencing the magnetisation angle between the primary and the secondary winding.

5) Basically, it is not possible to isolate this effect from the secondary winding and we shall obtain a variable phase angle rotation between primary and secondary according to the load conditions. However, we can compensate for this by using the prior art from PCT/NO01/00217 to compensate for the phase angle rotation.

6) Since the primary winding will immediately response to any load change from the secondary side, according to Lenz's law we shall achieve the desired regulating transformer effect,

C. In a preferred embodiment, the transformer according to the invention comprises only one control winding located in the winding compartment of the secondary winding. In principle, a control winding in the primary winding compartment is not necessary since the primary winding will rotate the domains in its direction and also rotate any domains established from a current in the secondary winding to the same direction. In order to obtain transformative connection between the orthogonal windings, the domains must be rotated as mentioned above in order to efficiently produce a magnetisation that is in a favourable direction for transformative connection between the primary and the secondary winding. The best that can be achieved is a rotation of 45 degrees for the domains. (From a different point of view, we twist the secondary winding relative to the primary winding in such a manner that some of the field from the primary winding passes through the secondary winding.)

D. In order to achieve transformer effect without distortion of the primary voltage, according to the invention an (AC) alternating voltage is used on the control winding, which as previously mentioned is located in the same winding compartment as the secondary winding. When current begins to flow in the control winding, this current will reinforce the connection with the primary side by the domains being helped in the right direction by the field from the secondary current and the field from the control current.

E. In a preferred embodiment, the control voltage in the transformer according to the invention will be in phase with or phase shifted 180 degrees relative to the voltage on the primary side in order to obtain a distortion-free transformation. The current in the control winding is made capable of regulation, thus enabling the connection and the electrical angle between the windings to be controlled by means of the alignment of the domains.

F. The transformer according to the invention may also advantageously be employed as a controlled rectifier or frequency converter. In order to achieve such a controlled rectifier effect from this transformer, two methods may be employed.

A. The transformer's secondary side is connected to a central point connected to diode rectifier topology. An AC voltage on the control winding will connect the secondary winding to the primary winding as long as it is located inside. By using two such transformers, a frequency converter can be made for motor control. See fig. A. This provides rectification similar to that for a normal transformer through T3 when the control winding for T3 is activated. During activation of T3 the control for T4 is switched off and there is no connection between the two circuits and high impedance in the secondary windings.

B. We will now have a positive direct voltage across the load U1. When we switch off control voltage for T3 and switch on control voltage for T4, we shall obtain a rectification where the voltage across U1 is negative. By varying the length of the negative and the positive rectifier period, we shall have a variable frequency control from 0 to 50 Hz.

C. The second method, see fig. B, entails an alternating AC voltage on the control windings of the two transformers MS1 and MS2, Vk1 and Vk2 that connect primary and secondary together according to a special pattern. See fig. C. Vp is the primary voltage that is common to the two transformers.

The connection sequence is illustrated in fig. C

Vk1 is connected during the first part of the positive phase and we have transformative connection to Vs1. We can see that it is slightly delayed in relation to the zero passage of Vs1. Vk1 and the voltage Vs2 are connected to the circuit during the zero passage. It is in phase with the voltage Vs1 and we obtain a circulating current through S1 and S2 that helps to reset S1 as Vk1 is disconnected. S2 is reset in the next sequence.

When domains change size and direction, the body's magnetisation will be altered accordingly, inducing voltages in windings where the domains are under an angle that is not orthogonal to the windings.

The transformative connection between the primary and the secondary side will be as for an ordinary transformer as long as the transformation occurs in the linear region of the magnetisation curve and as long as the directional dependence of the permeability in the plate is approximately symmetrical and the control current is in phase with the primary voltage and of such a strength that the direction of the domains is not changed during the primary voltage sequence.

With regard to the prior art from PCT/NO01/00217, which is hereby incorporated as a reference in its entirety, the invention relates to a new device, since the primary and the secondary windings do not have parallel, but right-angled winding axes.

The invention will now be described in detail with reference to the drawings.

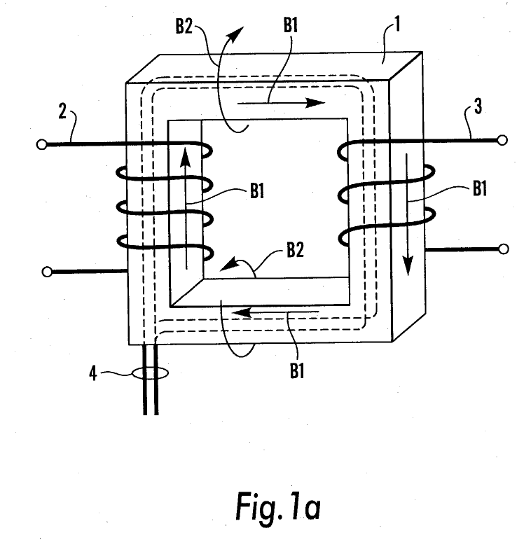

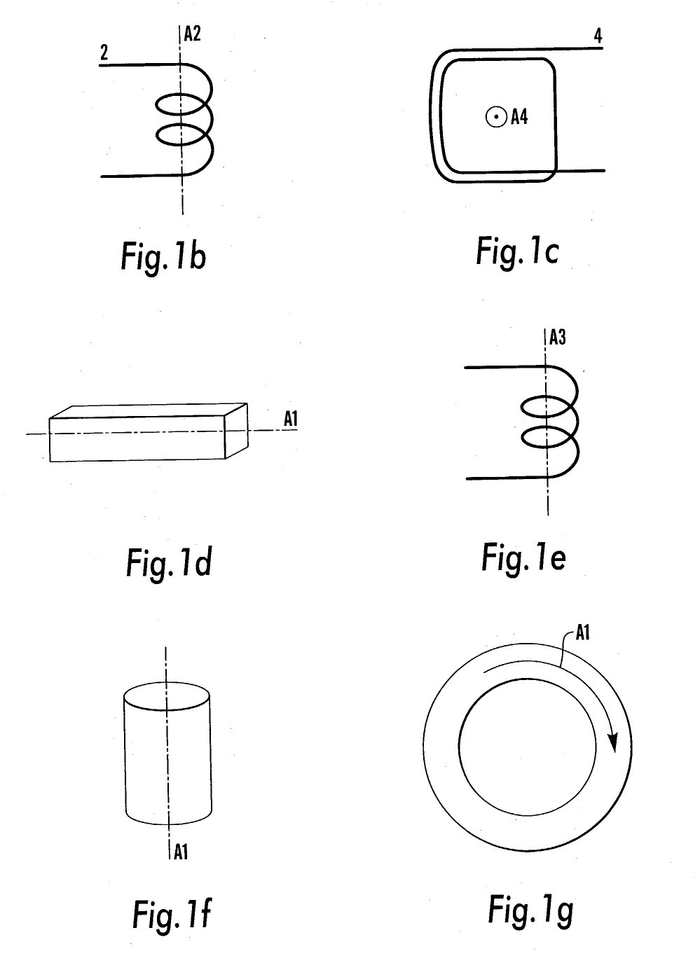

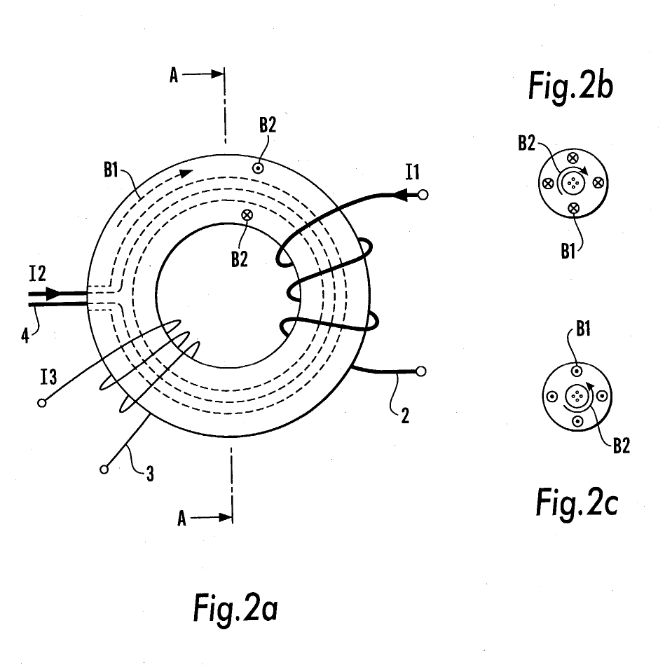

FIGS. 1 and 2 illustrate the basic principle of the invention and a first embodiment thereof.

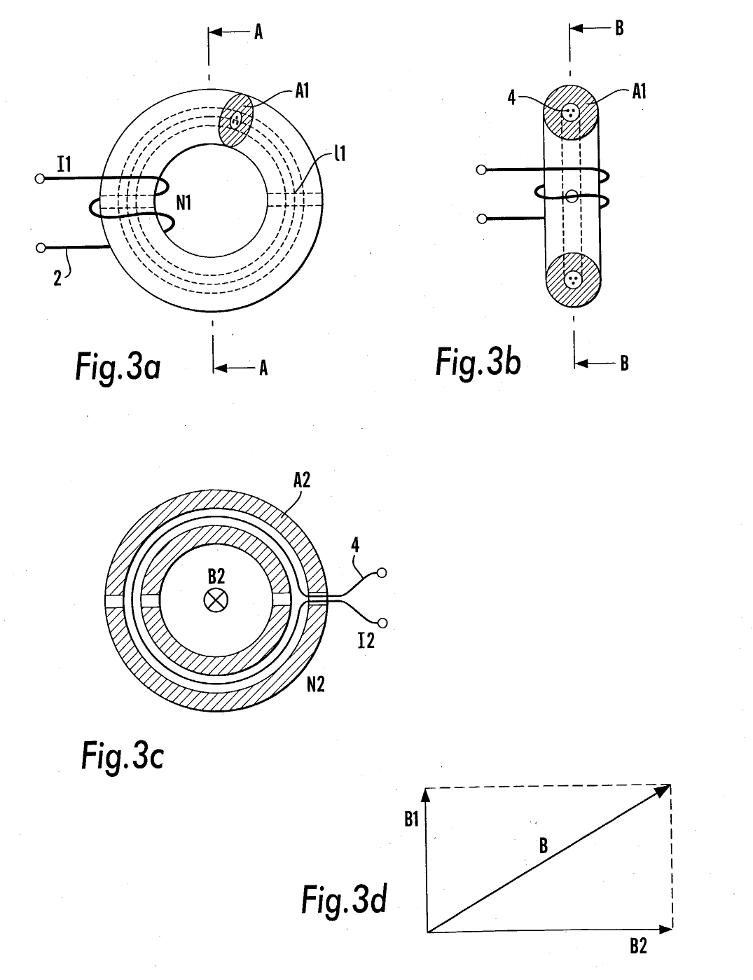

FIG. 3 illustrates the areas of the different magnetic fluxes involved in the device according to the invention.

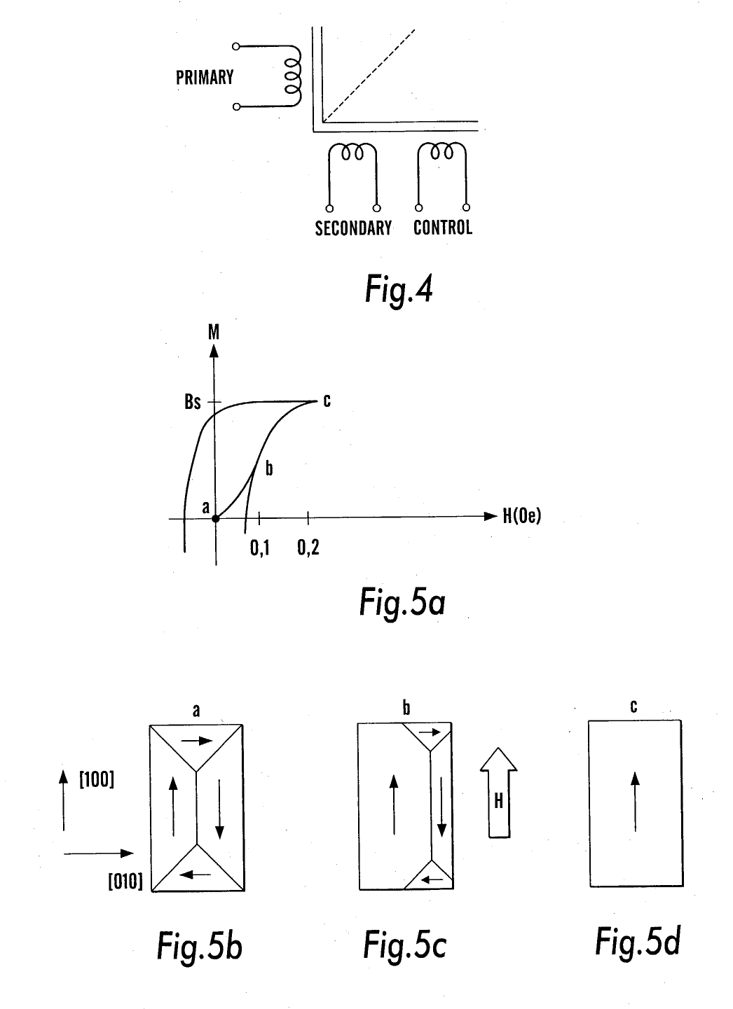

FIG. 4 illustrates a first equivalent circuit for the device according to the invention.

FIGS. 5 and 6 illustrate magnetisation curves and domains for the magnetic material in the device according to the invention.

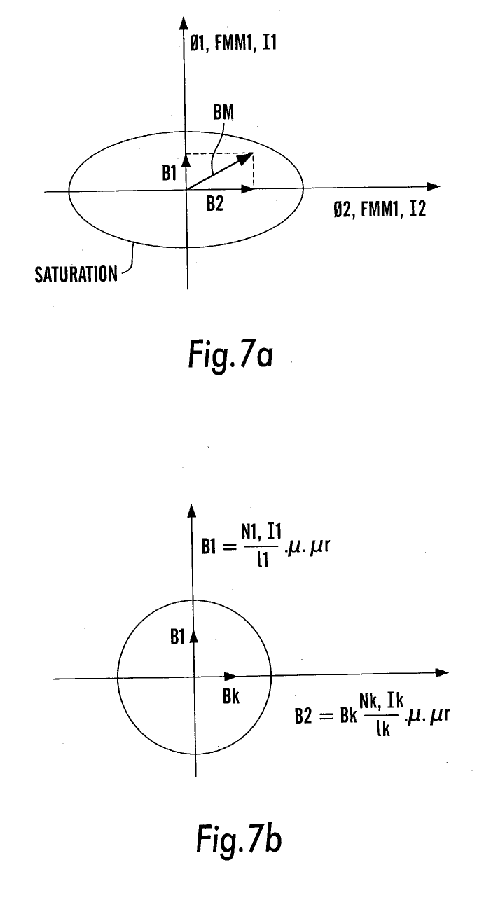

FIG. 7 illustrates flux densities for the main and the control winding.

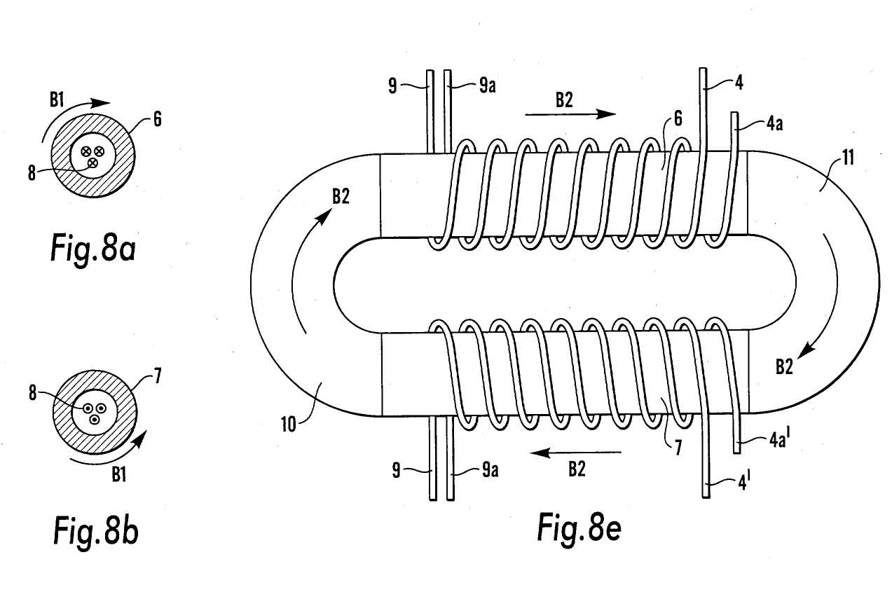

FIG. 8 illustrates a second embodiment of the invention.

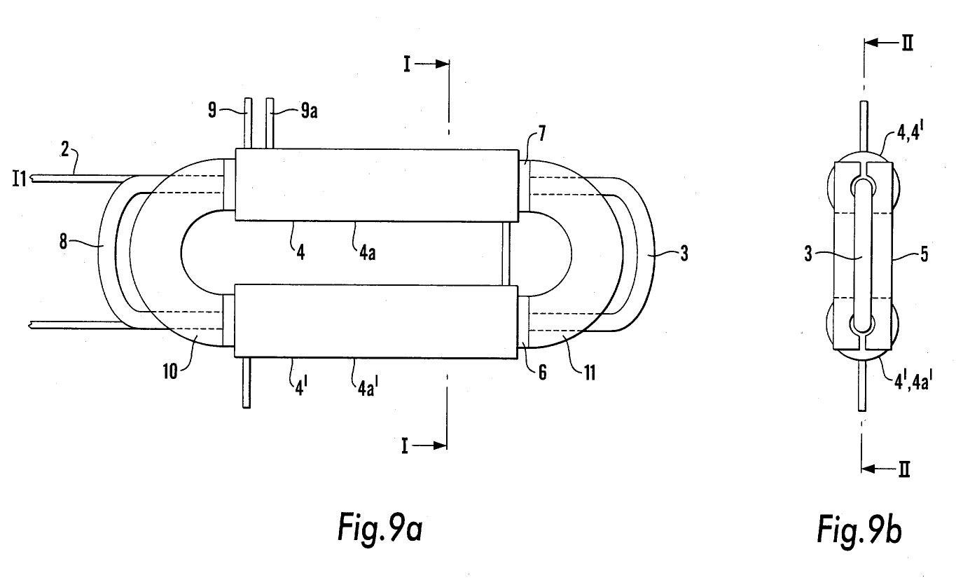

FIG. 9 illustrates the same second embodiment of the invention.

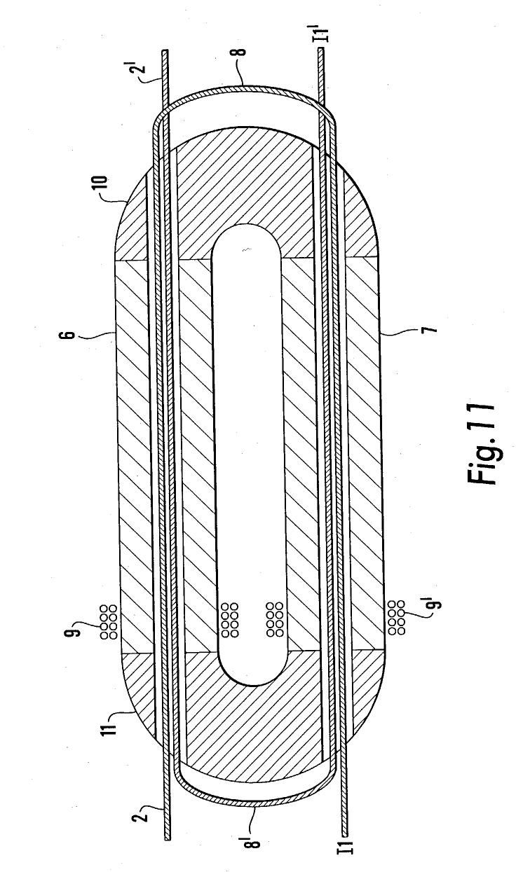

FIGS. 10 and 11 illustrate the second embodiment in section.

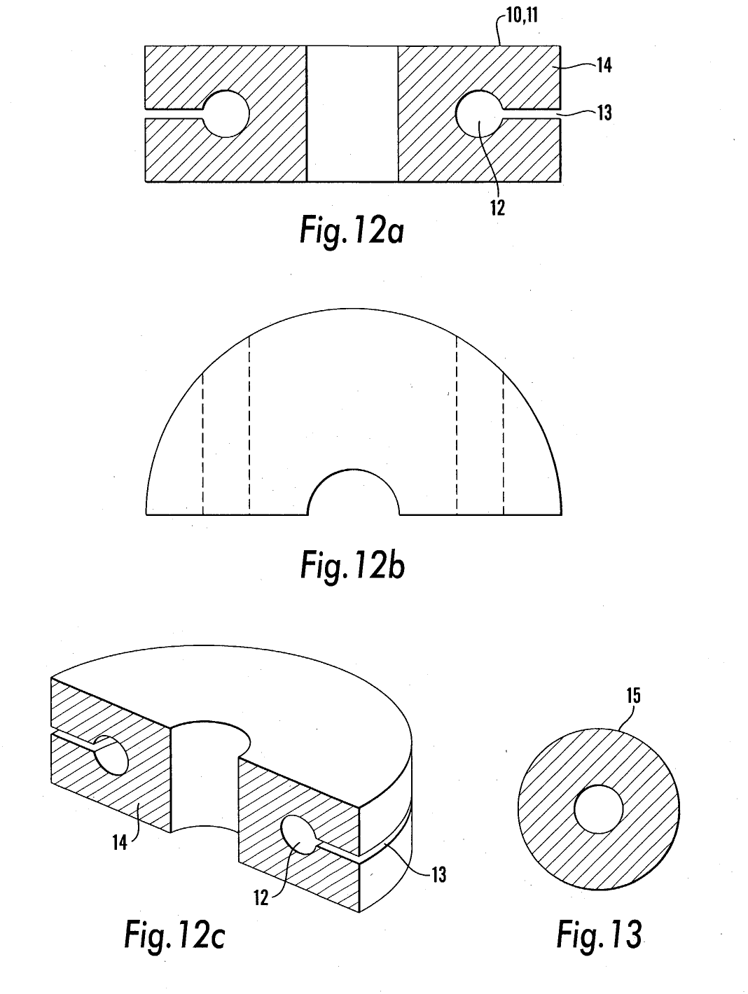

FIGS. 12-15 illustrate various embodiments of the magnetic field connectors in the said second embodiment of the invention.

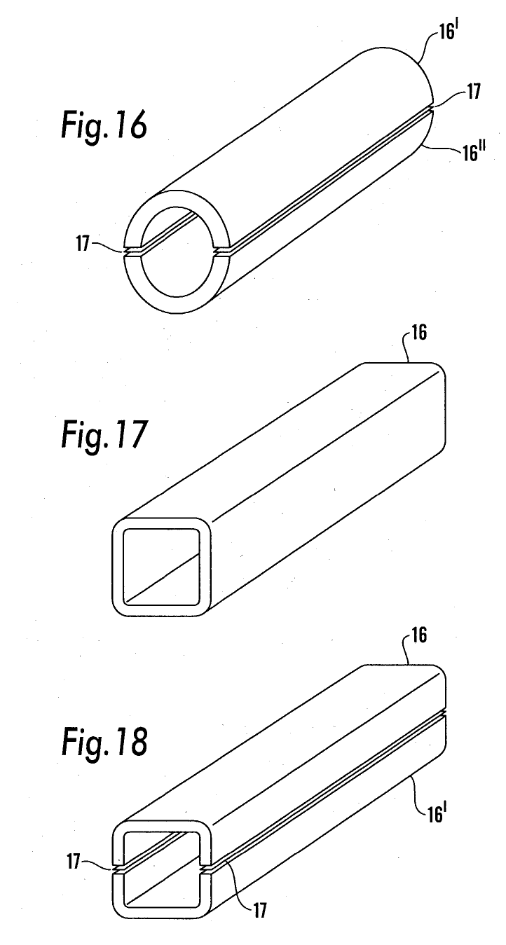

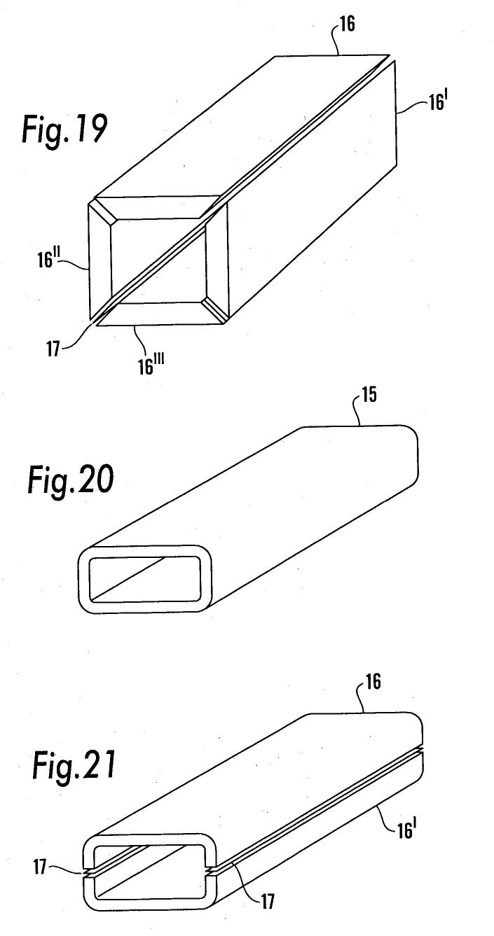

FIGS. 16-29 illustrate various embodiments of the tubular bodies in the second embodiment of the invention.

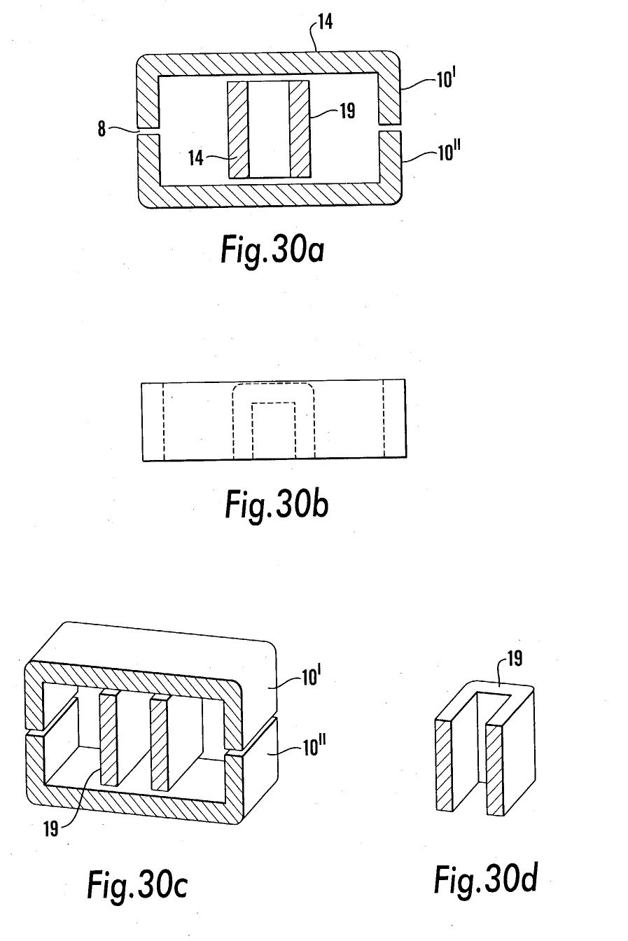

FIGS. 30-35 illustrate different aspects of magnetic field connectors for use in the second embodiment of the invention.

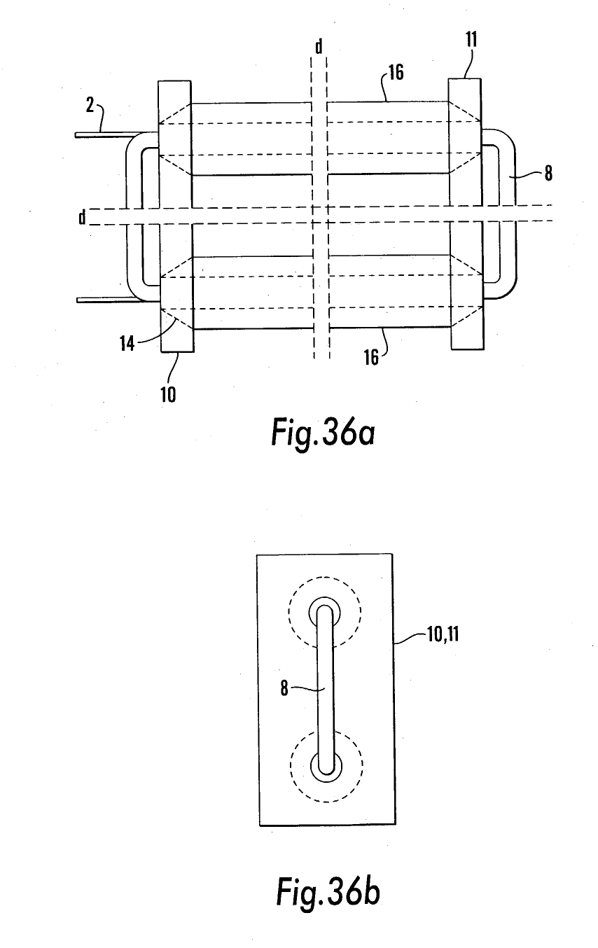

FIG. 36 illustrates an assembled device according to the second embodiment of the invention.

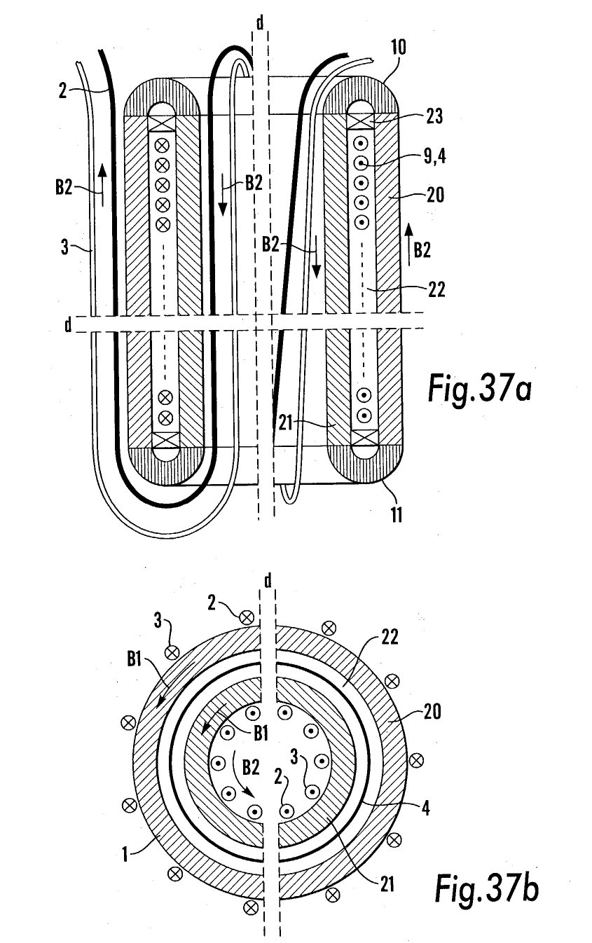

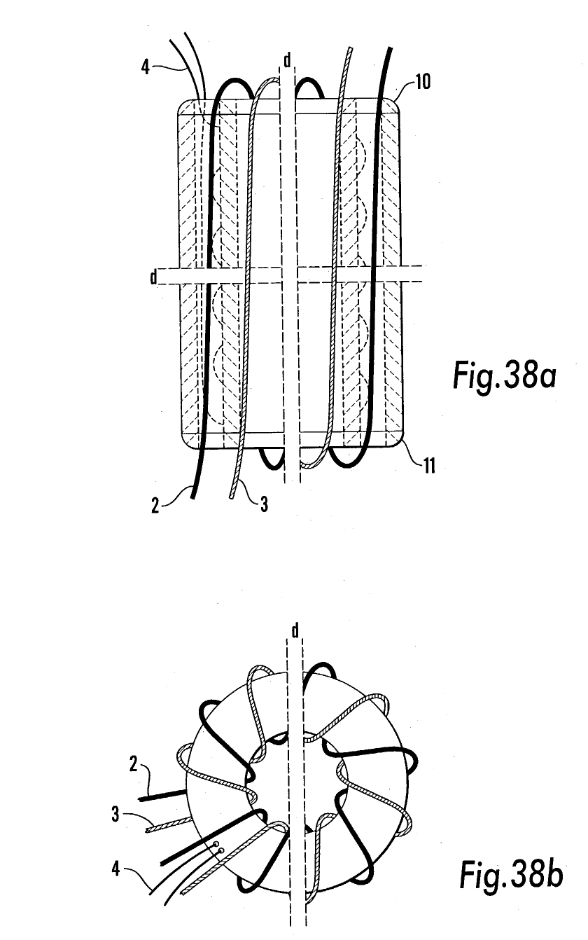

FIGS. 37 and 38 illustrate a third embodiment of the invention.

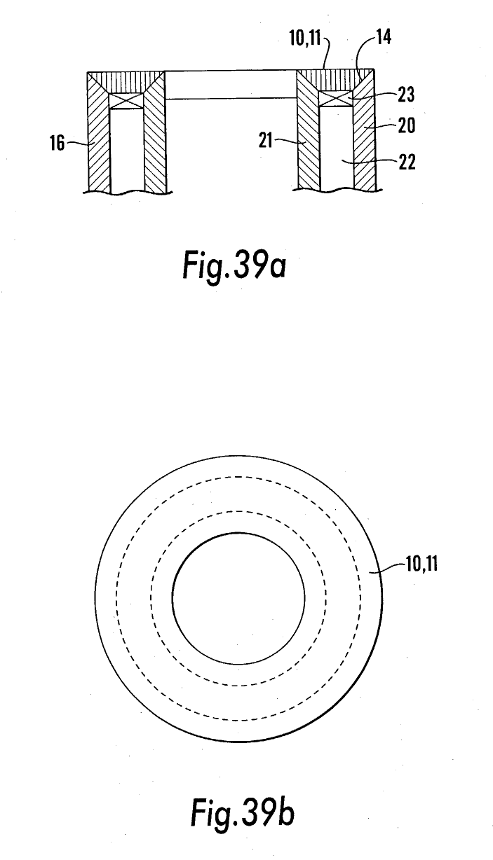

FIGS. 39-41 illustrate special embodiments of magnetic field connectors for use in the third embodiment of the invention.

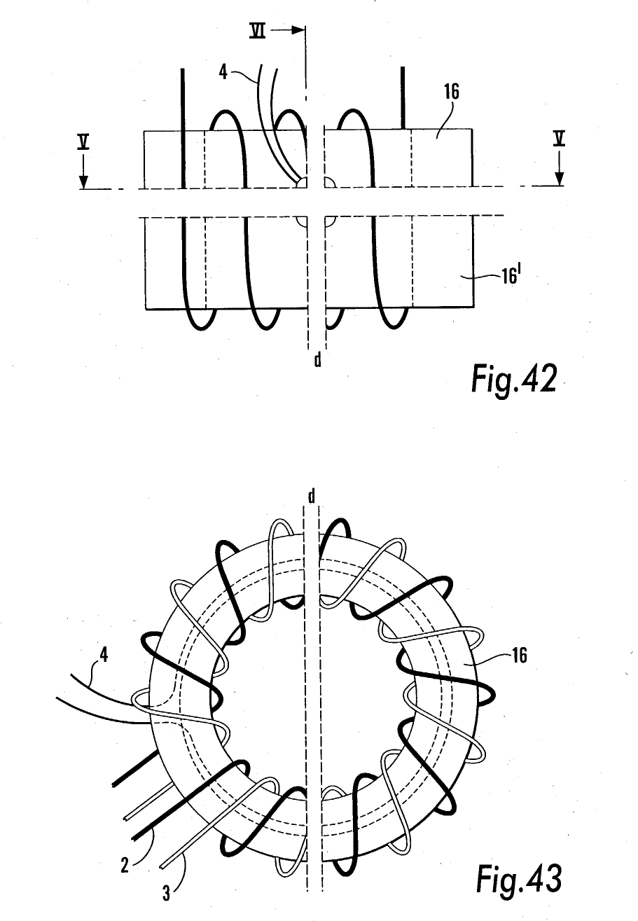

FIG. 42 illustrates the third embodiment of the invention adapted for use as a transformer.

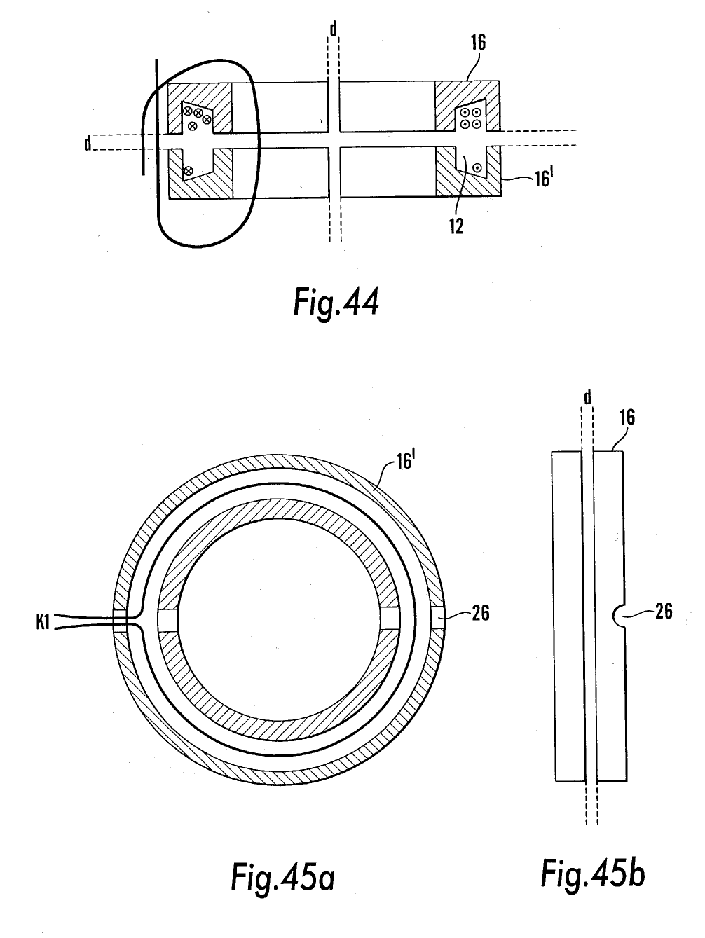

FIGS. 43 and 44 illustrate the fourth embodiment of the invention adapted to a powder-based magnetic material, and thereby without magnetic field connectors.

FIGS. 44 and 45 illustrate a section along lines VI-VI and V-V in FIG. 42.

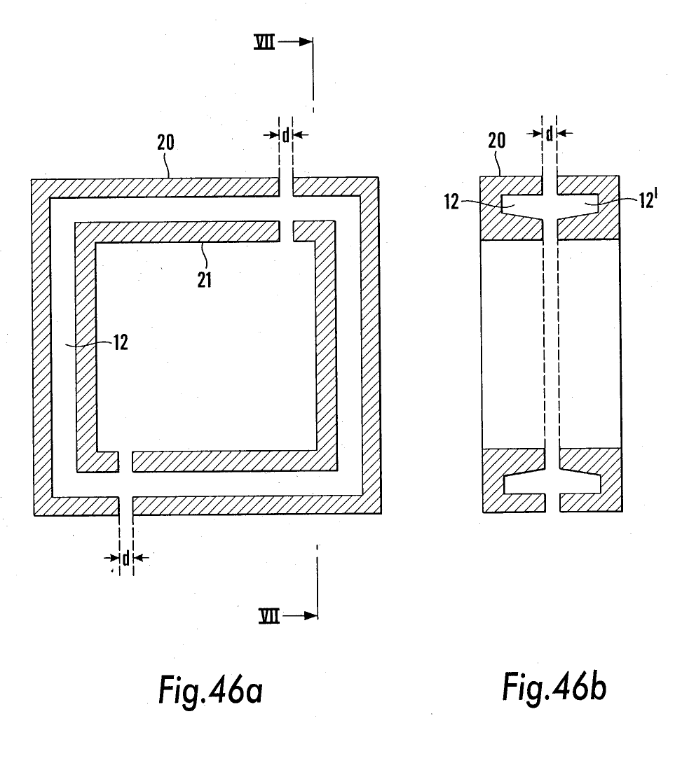

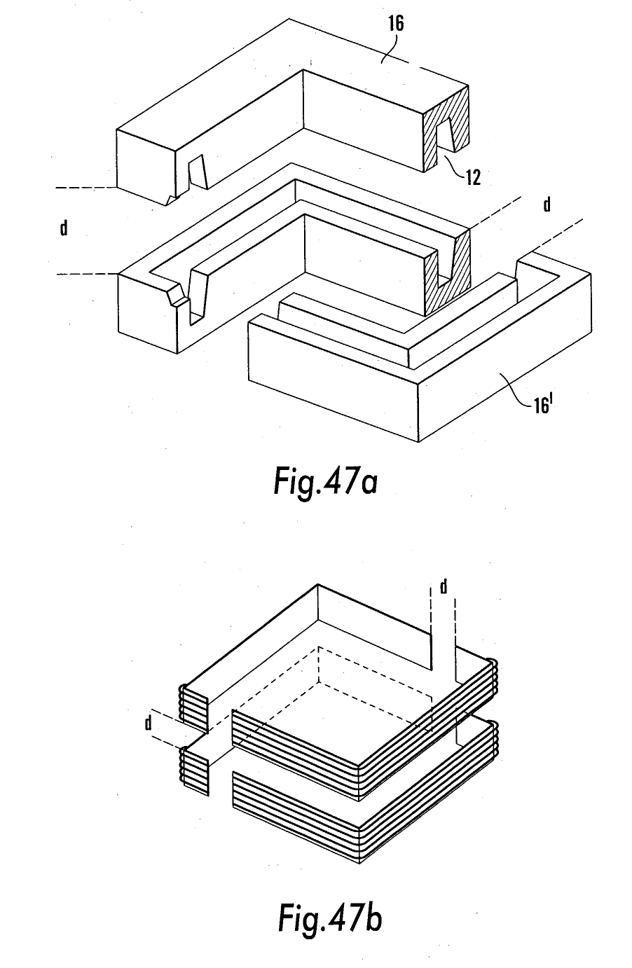

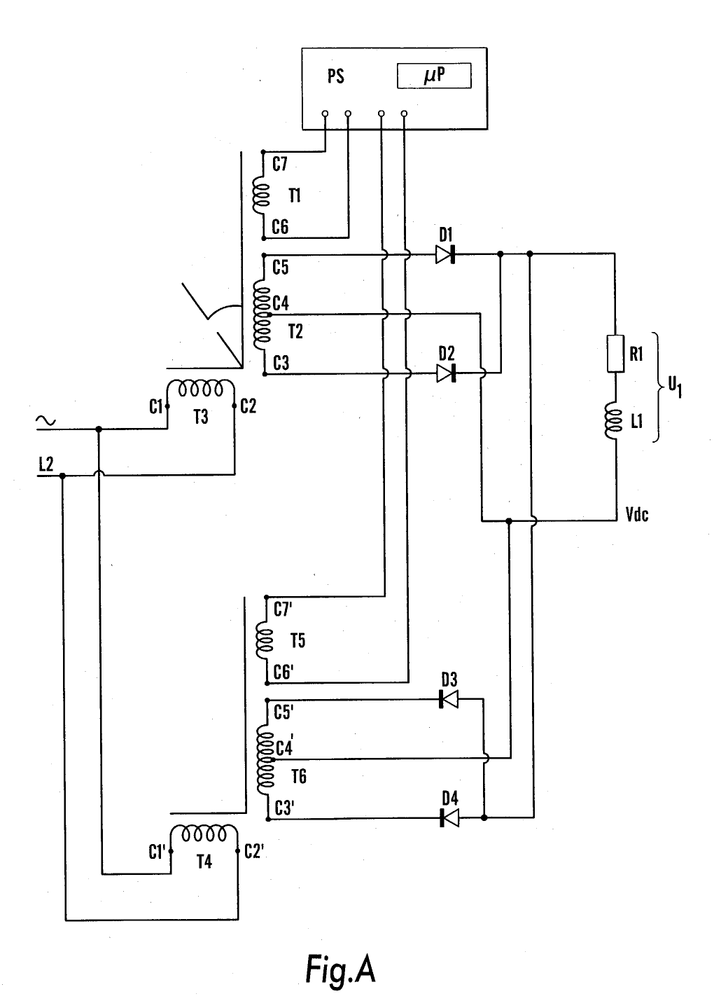

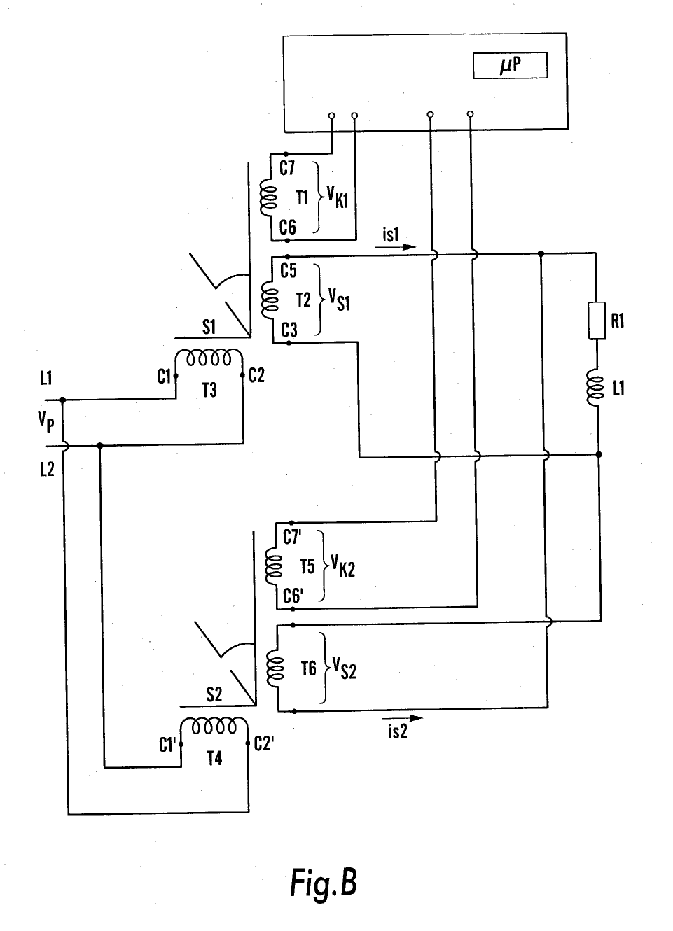

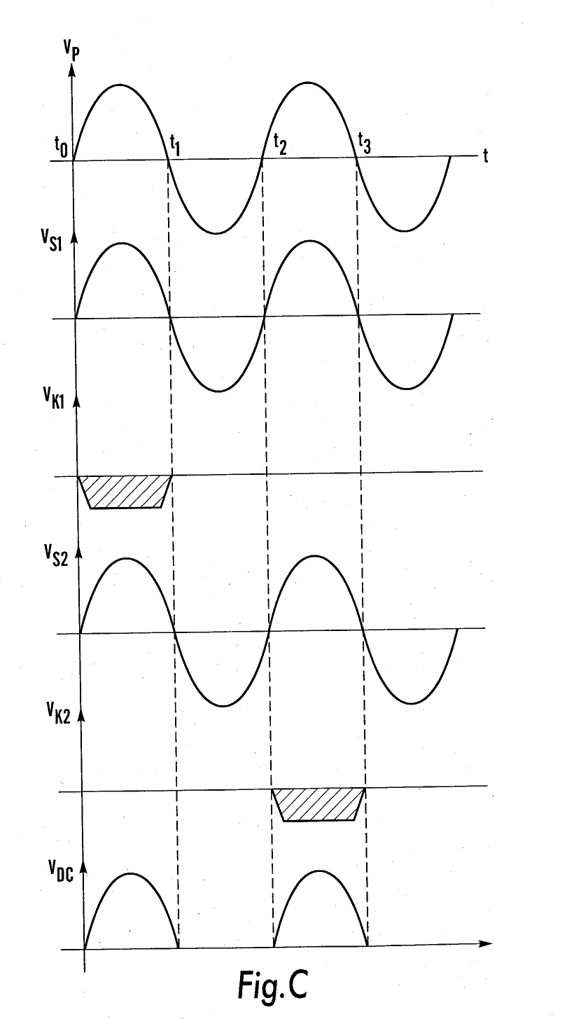

FIGS. 46 and 47 illustrate a core adapted to a powder-based magnetic material, and thereby without magnetic field connectors.

The invention will now be explained in principle in connection with FIGS. 1a and 1b.

In the entire description the arrows associated with magnetic field and flux will substantially indicate the directions thereof within the magnetic material. The arrows are depicted on the outside for the sake of clarity.

FIG. 1a illustrates a device comprising a body 1 of a magnetisable material that forms a closed magnetic circuit. This magnetisable body or core 1 may be annular in form or of another suitable shape. Around the body 1 is wound a first main winding 2, where the direction of the magnetic field H1 (corresponding to the direction of the flux density B1) that will be produced when the main winding 2 is excited will conform to the magnetic circuit. The main winding 2 resembles a winding in an ordinary transformer. In an embodiment the device comprises a second main winding 3, which is wound round the magnetisable body 1 in the same way as the main winding 2 and which will thereby provide a magnetic field extending substantially along the body 1 (i.e. parallel to H1, B1). Finally, the device comprises a third main winding 4, which in a preferred embodiment of the invention extends internally along the magnetic body 1. The magnetic field H2 (and thereby the flux density B2) that is created when the third main winding 4 is excited, will have a direction that is at right angles to the direction of the fields in the first and the second main winding (direction of H1, B1). According to a preferred embodiment of the invention the third main winding 4 constitutes a primary winding, the first main winding 2 the secondary winding and the second main winding 3 the control winding. In the topologies that are considered to be preferred in the present description, however, the turns in the main winding follow the field direction from the control field and the turns in the control winding follow the field direction of the working field.

FIGS. 1b-1g illustrate the definition of the axes and the direction of the various windings and the magnetic body. As far as the windings are concerned, we shall call the axis the normal of the surface defined by each turn. The secondary winding 2 will have an axis A2, the control winding 3 an axis A3 and the primary winding 4 an axis A4.

With regard to the magnetisable body 1, the longitudinal direction will vary according to the shape. If the body is elongated, the longitudinal direction A1 will coincide with the body's longitudinal axis. If the magnetic body is square as illustrated in FIG. 1a, it will be possible to define a longitudinal direction A1 for each leg of the square. Where the body is tubular, the longitudinal direction A1 will be the tube's axis, and for an annular body the longitudinal direction A1 will follow the circumference of the ring.

The invention is based on the principle of aligning the domains in the core in the magnetisable body 1 in relation to a first magnetic field H2 by changing a second magnetic field H1 that is at right angles to the first. Thus the field H2 may, for example, be defined as the working field and control the body's I domain direction (and thereby the behaviour of the working field H2) by means of the field H1 (hereinafter called control field H1). This will now be explained in greater detail.

The magnetisation in the core is directionally determined by the sources of the field that influence the domains in the material. Normally the winding compartment, i.e. the part of the core that contains the windings, is common to primary and secondary winding, with the result that domain direction and magnetisation are also common. In a preferred embodiment of the invention the winding compartments are orthogonal with the result that the fields from the two windings are orthogonal and consequently there is no magnetic connection between the windings as long as no current is flowing in the control winding and the secondary winding.

As already mentioned, in FIGS. 1a and 2a winding 4 is the primary winding and winding 2 the secondary winding while winding 3 is the control winding. FIG. 4 shows A1 as the flux area for secondary winding 2 and control winding 3 and this area may be called the area for the internal winding compartment iws, and A2 the flux area for the primary winding 4, or the area of the external winding compartment ews. Depending on the kind of conversion and connection required, it will be possible to give the areas equal or unequal dimensions.

FIG. 4 is a diagram illustrating the transformer according to the invention where the windings are located with parallel and right-angled axes, and where the magnetisation direction is also represented.

In order to achieve a transformative connection between the two orthogonal windings, the domains and thereby the magnetisation must be aligned in such a manner that the angle between the domains and the windings that have to be influenced is different from 90 degrees. The best that can be achieved with connection between two orthogonal windings is to align the magnetisation in the body 1 by means of a control winding to 45 degrees. This means that with an equal number of turns on the primary and the secondary winding and the same flux area, a maximum of approximately 70% of the voltage can be transformed since sinus of 45 degrees is 0.707 and is the part of the flux area a winding rotated at 45 degrees relative to a source winding will cover.

The essence of what is occurring is illustrated in FIGS. 5 and 6.

FIG. 5 illustrates the magnetisation curves for the entire material of the magnetisable body 1 and the domain change under the influence of the H1 field from the secondary winding 2.

FIG. 6 illustrates the magnetisation curves for the entire material of the magnetisable body 1 and the domain change under the influence of the H1 field in the direction of the winding 4.

FIGS. 7a and 7b illustrate the flux densities B1 (where the field H1 is established by the secondary winding) and B2 (corresponding to the primary current). The ellipse illustrates the saturation limit for the B fields, i.e. when the B field reaches the limit, this will cause the material of the magnetisable body 1 to reach saturation. The design of the ellipse's axes will be given by the field length and the permeability of the two fields B1 (H1) and B2 (H2) in the core material of the magnetisable body 1.

By letting the axes in FIG. 7 express the MMK distribution or the H-field distribution, a picture can be seen of the magnetomotive force from the two currents I1 and I2. The operative range of the transformer will be within the saturation limit and it is particularly important to take account of this when designing the transformer for the magnetisation fields in a connection between two orthogonal windings.

FIG. 8 is a schematic illustration of a second embodiment of the invention.

FIG. 9 illustrates the same embodiment of a magnetically influenced connector provided in a preferred embodiment of the transformer according to the invention, where FIG. 9a illustrates the assembled connector and FIG. 9b is an end view of the connector.

FIG. 10 illustrates a section along line II in FIG. 9b.

As illustrated, for example, in FIG. 10, the magnetisable body 1 is co mposed inter alia of two parallel tubes 6 and 7 made of a magnetisable material. An electrically insulated conductor 8 (FIGS. 9a, 10) is passed continuously in a path through the first tube 6 and the second tube 7 N number of times, where N=1, . . . r, forming the primary main winding 2, with the conductor 8 extending in the opposite direction through the two tubes 6 and 7, as is clearly illustrated in FIG. 10. Even though the conductor X is only shown extending through the first tube 6 and the second tube 7 twice, it should be self-explanatory that it is possible for the conductor 8 to extend through the respective tubes either only once or possibly several times (as indicated by the fact that the winding number N can vary from 0 to r), thereby creating a magnetic field H1 in the parallel tubes 6 and 7 when the conductor is excited. A combined control and secondary winding 4,4′, composed of the conductor 9, is wound round the first tube and the second tube (6 and 7 respectively), in such a manner that the direction of the field H2 (B2) that is created on the said tubes when the winding 4 is excited will be oppositely directed, as indicated by the arrows for the field B2 (H2) in FIG. 8. Magnetic field connectors 10, 11 are mounted at the ends of the respective tubes 6, 7 in order to interconnect the tubes fieldwise in a loop. The conductor 8 will be able to convey a load current I1 (FIG. 9a). The tubes' 6, 7 length and diameter will be determined on the basis of the power and voltage that have to be connected. The number of turns N1 on the main winding 2 will be determined by the reverse blocking ability for voltage and the cross-sectional area for the magnitude of the working flux Φ2. The number of turns N2 on the control winding 4 is determined by the conversion ratio required for the special transformer.

Another possibility is to arrange the winding 4 as primary winding and the winding 2 as control and secondary winding.

FIG. 11 illustrates an embodiment where the primary and the secondary main windings have been interchanged. In reality, the solution in FIG. 11 differs from that illustrated in FIGS. 9a and 10 only by the fact that instead of a single insulated conductor 8, which is passed through the tubes 6 and 7, two separate oppositely directed conductors, so-called secondary conductors 8 and control conductors 8′ are employed, in order thereby to achieve a voltage converter function in the magnetically influenced device according to the invention. The design basically resembles that illustrated in FIGS. 8, 9 and 10. The magnetisable body 1 comprises two parallel tubes 6 and 7. An electrically insulated secondary conductor 8 is passed continuously in a path through the first tube 6 and the second tube 7 N1 number of times, where N1=1, . . . r, with the conductor 8 extending in the opposite direction through the two tubes 6 and 7. An electrically insulated control conductor 8′ is passed continuously in a path through the first tube 6 and the second tube 7 N1′ number of times, where N1′=1, . . . r, with the conductor 8′ extending in the opposite direction relative to the conductor 8 through the two tubes 6 and 7. At least one primary winding 4 and 4′ is wound round the first tube 6 and the second tube 7 respectively, with the result that the field direction created on the said tubes is oppositely directed. In the same way as for the embodiment according to FIGS. 8, 9 and 10, the magnetic field connectors 10, 11 are mounted at the end of the respective tubes 6, 7 in order to interconnect the tubes 6 and 7 fieldwise in a loop, thereby forming the magnetisable body 1. Even though for the sake of simplicity in the drawings the conductor 8 and the conductor 8′ are illustrated with only one pass through the tubes 6 and 7, it will be immediately apparent that both the conductor 8 and the conductor 8′ will be able to be passed through the tubes 6 and 7 N1 and N1′ number of times respectively. The tubes' 6 and 7 length and diameter will be determined on the basis of the power and voltage that have to be converted. For a transformer with a conversion ratio (N1:N1′) equal to 10:1, in practice ten conductors will be used as conductors 8 and only one conductor 4.

An embodiment of a magnetic field connector 10 and/or 11 is illustrated in FIG. 12. A magnetic field connector 10, 11 is illustrated composed of magnetically conducting material, wherein two preferably circular apertures 12 for the conductor 8 in the winding 2 (see, e.g., FIG. 10) are machined out of the magnetic material in the connectors 10, 11. Furthermore, a gap 13 is provided which interrupts the magnetic field path of the conductor 8. End surface 14 is the connecting surface for the magnetic field H2 from the winding 4 consisting of conductor 9 and 9′ (FIG. 10).

FIG. 13 illustrates a thin insulating film 15 which will be placed between the end surface of tubes 6 and 7 and the magnetic field connector 10, 11 in a preferred embodiment of the invention.

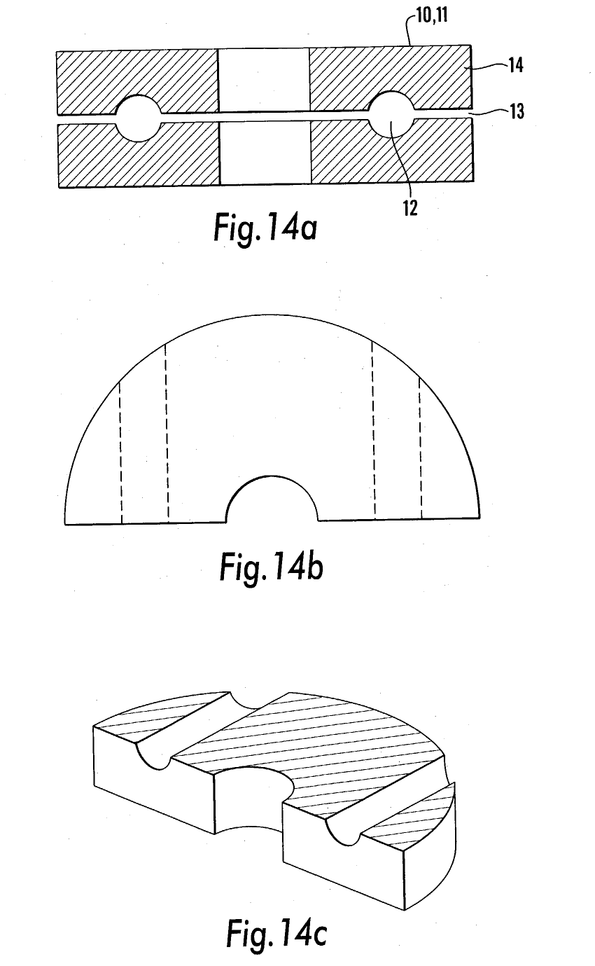

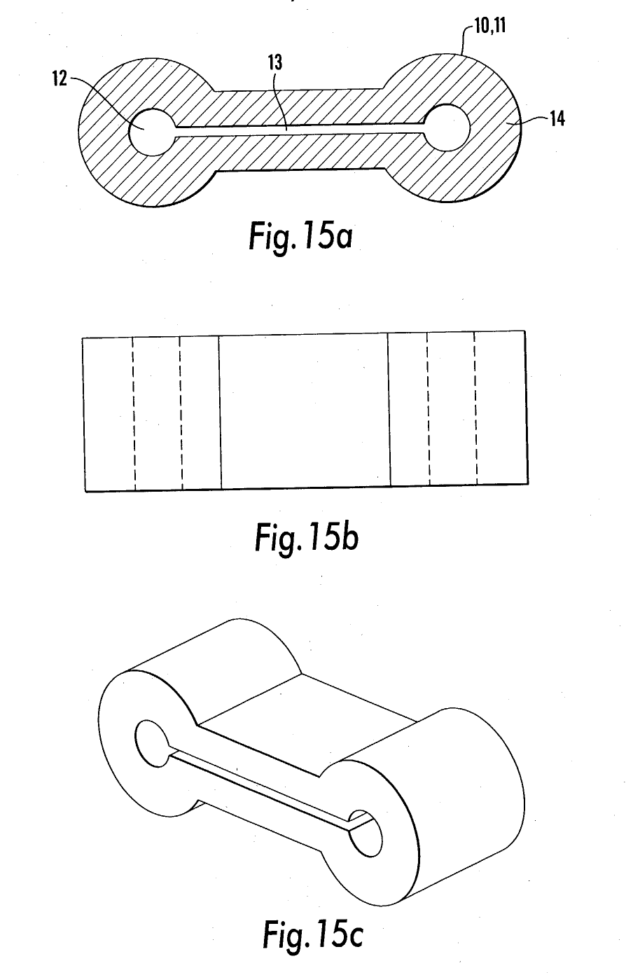

FIGS. 14 and 15 illustrate other alternative embodiments of the magnetic field connectors 10, 11.

FIGS. 16-29 illustrate various embodiments of a core 16, which in the embodiment illustrated in FIGS. 9, 10 and 11 forms the main part of the tubes 6 and 7, which preferably together with the magnetic field connectors 10 and 11 form the magnetisable body 1.

FIG. 16 illustrates a cylindrical core part 16, which is divided lengthwise as illustrated and where one or more layers 17 of insulating material are placed between the two core halves 16,′ 16″.

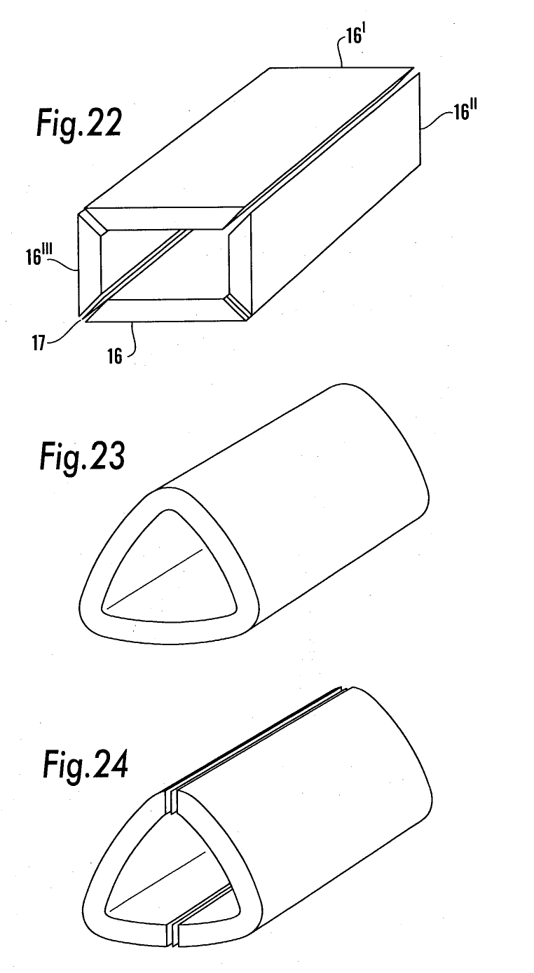

FIG. 17 illustrates a rectangular core part 16 and FIG. 18 illustrates an embodiment of this core part 16 where it is divided in two with partial sections in the lateral surface. In the embodiment illustrated in FIG. 18 one or more layers of insulating material 17 are placed between the core halves 16, 16′. A further variant is illustrated in FIG. 22 where the partial section is placed in each corner.

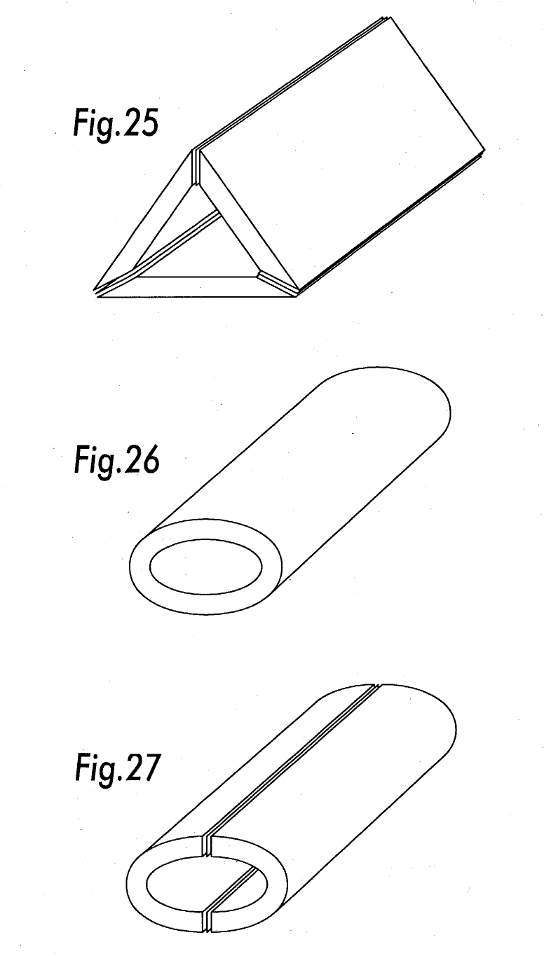

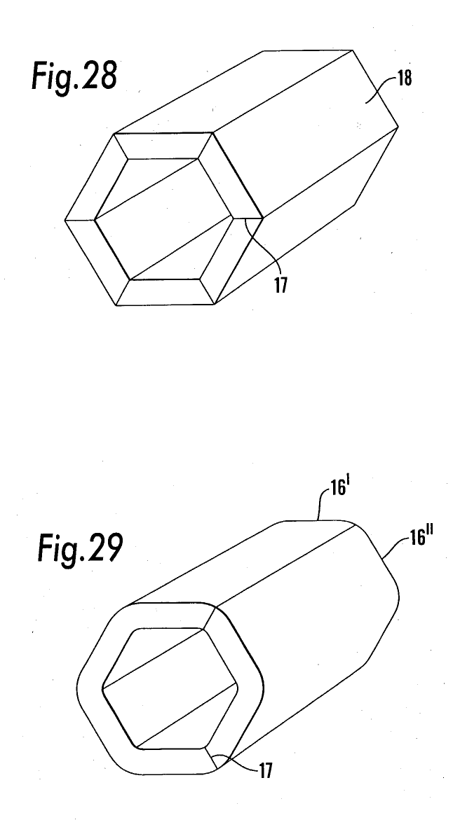

FIGS. 20, 21 and 22 illustrate a rectangular shape. FIGS. 23, 24 and 25 illustrate the same for a triangular shape. FIGS. 26 and 27 illustrate an oval variant, and finally FIGS. 28 and 29 illustrate a hexagonal shape. In FIG. 28 the hexagonal shape is composed of 6 equal surfaces 18 and in FIG. 27 the hexagon consists of two parts 16′ and 16″. Reference numeral 17 refers to a thin insulating film.

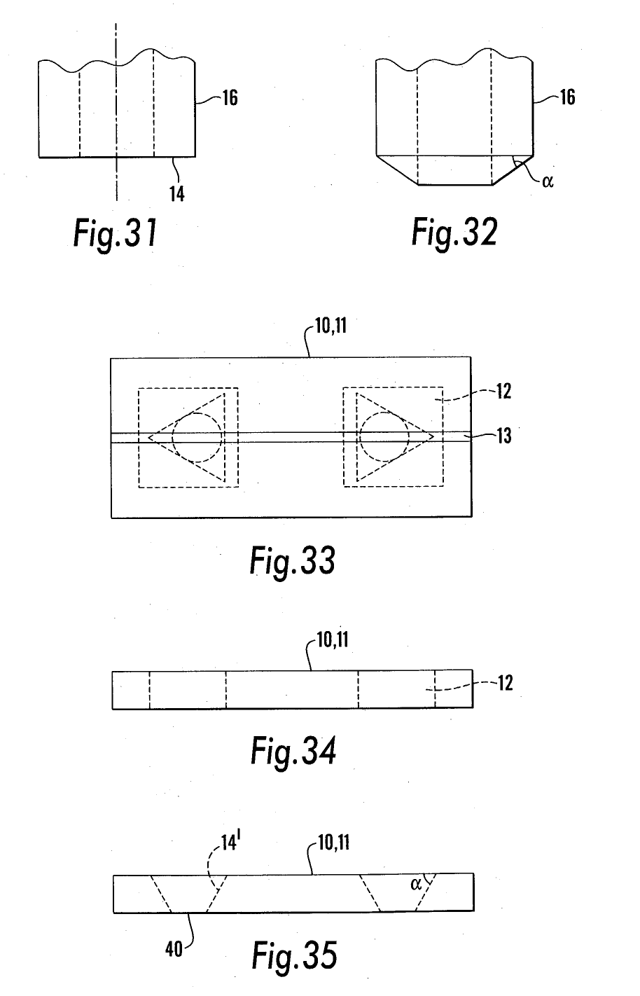

FIGS. 30 and 31 illustrate a magnetic field connector 10, 11 that can be used as a control field connector between the rectangular and square main cores 16 (illustrated in FIGS. 10-11 and 20-22 respectively). This magnetic field connector comprises three parts 10′, 10″ and 19.

FIG. 31 illustrates an embodiment of a core part or main core 16 where the end surface 14 or the connecting surface for the control flux is at right angles to the axis of the core part 16.

FIG. 32 illustrates a second embodiment of the core part 16 where the connecting surface 14 for the control flux is at an angle α relative to the axis of the core part 16.

FIGS. 33-39 illustrate various designs of the magnetic field connector 10, 11, which are based on the fact that the connecting surfaces 14′ of the magnetic field connector 10, 11 are at the same angle as the end surfaces 14 to the core part 16.

FIG. 33 illustrates a magnetic field connector 10, 11 in which different hole shapes 12 are indicated for the main winding 2 based on the shape of the core part 16 (round, triangular, etc.).

In FIG. 34 the magnetic connector 10, 11 is flat. It is adapted for use with core parts 16 with right-angled end surfaces 14.

In FIG. 35 an angle α′ is indicated to the magnetic field connector 10, 11, which is adapted to the angle cc to the core part 16 (FIG. 32) with the result that the end surface 14 and the connecting surface 14′ coincide.

In FIG. 36a an embodiment of the invention is illustrated with an assembly of magnetic field connectors 10, 11 and core parts 16. FIG. 36b illustrates the same embodiment viewed from the side.

Even though only a few combinations of magnetic field connectors and core parts are described in order to illustrate the invention, it will be obvious to a person skilled in the art that other combinations are entirely possible and will therefore fall within the scope of the invention.

It will also be possible to switch the positions of the primary winding and the secondary and control windings. However, the control winding will preferably follow the same winding compartment as the secondary winding.

FIGS. 37 and 38 are a sectional illustration and a view respectively illustrating a third embodiment of a magnetically influenced voltage connector device. The device comprises (see FIG. 37b) a magnetisable body 1 comprising an external tube 20 and an internal tube 21 (or core parts 16, 16′) that are concentric and made of a magnetisable material with a gap 22 between the external tube's 20 inner wall and the internal tube's 21 outer wall. Magnetic field connectors 10, 11 between the tubes 20 and 21 are mounted at respective ends thereof (FIG. 37a). A compartment 23 (FIG. 37a) is placed in the gap 22 thus keeping the tubes 20, 21 concentric. A primary winding 4 composed of conductors 9 is wound round the internal tube 21 and is located in the said gap 22 The winding axis A2 for the primary winding 4 therefore coincides with the axis A1 of the tubes 20 and 21 An electrical current-carrying or secondary winding 2 composed of the current conductor 8 is passed through the internal tube 21 along the outside of the external tube 20 N1 number of times, where N1=1, . . . r. With the primary winding 4 cooperating with the secondary winding 2 or the said current-carrying conductor 8, an easily constructed, but efficient magnetically influenced transformer or switch is obtained. An electrical current-carrying or control winding 3 composed of the current conductor 8′ is passed through the internal tube 21 and along the outside of the external tube 20 N1 number of times, where N1=1, . . . , r. This embodiment of the device can also be modified so that the tubes 20, 21 do not have a round cross section but a cross section that is square, rectangular, triangular, etc. We must define <<winding compartment)>> better. It is not exactly a cavity in the core, since the windings are wound round the walls of the core.

It is also possible to wind the primary main winding round the internal tube 21, in which case the axis A2 for the main winding will coincide with the axis A1 of the tubes while the control and the secondary winding are wound round the tubes on the inside of 21 and the outside of 20.

FIGS. 39-41 illustrate different embodiments of the magnetic field connector 10, 11, which are specially adapted for the last-mentioned embodiment of the invention, i.e. that described in connection with FIGS. 37 and 38.

FIG. 39a is a sectional view and FIG. 39b a view from above of a magnetic field connector 10, 11 with connecting surfaces 14′ at an angle relative to the axis of the tubes 20, 21 (the core parts 16) and naturally the internal 21 and external 20 tubes will also be at the same angle to the connecting surfaces 14.

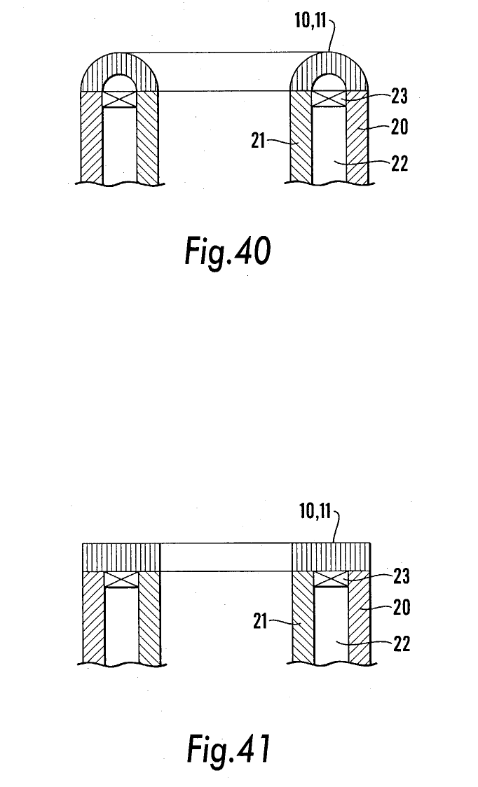

FIGS. 40 and 41 illustrate other variants of the magnetic field connector 10, 11 where the connecting surfaces 14′ of the control field H2 (B2) are at right angles to the main axis of the core parts 16 (tubes 20, 21).

FIG. 40 illustrates a hollow semi-toroidal magnetic field connector 10, 11 with a hollow, semicircular cross section, while FIG. 39 illustrates a toroidal magnetic field connector with a rectangular cross section.

1. A controllable transformer device comprising a body (1) of a magnetic material, a primary winding (4) wound round the body (1) about a first axis, a secondary winding (2) wound round the body (1) about a second axis at right angles to the first axis, and a control winding (3) wound around the body (1) about a third axis, coincident with the first axis.

2. A controllable transformer,
characterised in that the body (1) comprises a hollow core with an internal winding compartment and an external winding compartment.

3. A controllable transformer according to claim 2,
characterised in that the primary winding is arranged in the external winding compartment and the secondary winding and the control winding are arranged in the internal winding compartment.

4. A controllable transformer according to claim 2,
characterised in that the primary winding (4) is arranged in the internal winding compartment and the secondary and the control winding are arranged in the external winding compartment.

5. A controllable transformer according to one of the preceding claims,
characterised in that it is equipped with magnetic field connectors.

6. A method for controllable conversion of a primary alternating current/voltage to a secondary alternating current/voltage by the use of the controllable transformer according to one of claims 1 to 5,
characterised by the following steps;
the primary winding is fed with the primary alternating current voltage,
the control winding is fed with an alternating voltage which is either in phase or phase shifted 180° relative to the primary voltage,
the control winding is fed with a variable current, with the result that the transforyner's conversion ratio if controlled by means of the control current.

7. A method according to claim 6, where the control winding is fed with a pulsed AC current.

8. A method for controllable conversion of a primary alternating current/voltage to a secondary alternating current/voltage with the use of the controllable transformer according to one of claims 1 to 5, where:
1) The control voltage is in phase or antiphase with the primary voltage in order to achieve distortion-free transformative connection.
2) Through a slow change in the amplitude of the control voltage, the direction of the domain change or the magnetisation angle between primary and secondary winding can be changed and thereby the voltage transfer.
3) Through introduction of an inductance in the control circuit it will be possible to suppress the effect of the direct transformative connection between secondary and control winding.
4) The secondary winding will act as a control winding by mmf therefrom being added to mmf from the control winding and influencing the magnetisation angle between the primary and the secondary winding.
5) Basically, it is not possible to isolate this effect from the secondary winding and we shall obtain a variable phase angle rotation between primary and secondary according to the load conditions. However, we can compensate for this by using the prior art from PCT/NO01/00217 to compensate for the phase angle rotation.
6) Since the primary winding will immediately reply to any load change from the secondary side, according to Lenz's law we shall achieve the desired regulating transformer effect.

9. A method for rectification by means of a transformer device according to one of the claims 1-5, where the transformer's secondary side is connected to a central point connected to diode rectifier topology, an AC voltage on the control winding connects the secondary winding to the primary winding, two such transformers form a frequency converter for motor control (fig. A), where a rectification is performed similar to that for a normal transformer through T3 when the control winding for T3 is activated and during the activation of T3 the control is switched off and there is no connection between the two circuits and high impedance in the secondary windings, there is a positive direct voltage across the load U1 and when control voltage for T3 is switched off and control voltage for T4 switched on, a rectification is obtained where the voltage across U1 is negative, and by varying the length of the negative and the positive rectifier period, a variable frequency control from 0 to 50 Hz will be obtained.

10. A method for rectification by means of a transformer device according to one of the claims 1-5, where (fig. B) an alternating AC voltage on the control windings of the two transformers MS1 and MS2, Vk1 and Vk2 connects primary and secondary together according to a special pattern (fig. C), Vp is the primary voltage that is common to the two transformers, Vk1 is connected during the first part of the positive phase and transformative connection to Vs1 is obtained, that is slightly delayed in relation to the zero passage of Vs1, Vk2 and the voltage Vs2 are connected to the circuit during the zero passage, it is in phase with the voltage Vs1 and a circulating current is obtained through S1 and S2 that helps to reset S1 as Vk1 is disconnected and S2 is reset in the next sequence.
